(19) United States
(12) Patent Application Publication
(10) Pub. No.: US 2008/0040808 A1
(43) Pub. Date: Feb. 14, 2008

(54) Document management apparatus, computer readable medium, method for managing document, and computer data signal

(75) Inventor: Katsuji Tokie, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/785,454

(22) Filed: Apr. 18, 2007

(30) Foreign Application Priority Data
Aug. 10, 2006 (JP) 2006-217905

(51) Int. Cl. H04L 9/00

(52) U.S. Cl. 726/26

(57) ABSTRACT

A document management apparatus includes: a first requesting portion; a first receiving portion; a first storage; an acquiring portion; a second requesting portion; a second receiving portion; and a second storage.

### CROSS-REFERENCE TO RELATED APPLICATIONS

This application is based on and claims priority under 35 U.S.C. 119 from Japanese Patent Application No. 2006-21705 filed Aug. 10, 2006.

### BACKGROUND

1. Technical Field

The present invention relates to a document management apparatus, to a computer readable medium, to a method for managing document, and to a computer data signal.

2. Related Art

A digital signature technique is employed to prove the integrity of an author, who creates a document to be processed by a computer, and to also prove that the created document is not tampered. In the case of a practical example, a hash value of a document to be signed is received by a computer. The received hash value is encrypted according to a private key of a signer as signature information. The signature information is held together with the document. When it is verified whether the document is tampered, a hash value (or verifying hash value) of the document at the time of verification is generated. Also, the signature information held together with the document is decrypted using a public key include in certification information of a verifier. Subsequently, the generated verifying has value is compared with a result of decrypting to thereby verify whether the document is tampered.

Also, there is a technique (what is called a timestamping technique) of encrypting a hash value, to which data representing a time and date of processing a document is added, to link the document to the time and date by a time stamp user.

According to such techniques of a digital signature and a timestamp, an expiration date is set for each piece of signature information and timestamp information, so as to maintain service quality. After the expiration date, an operation is performed without trusting the signature or time stamp information.

### SUMMARY

According to a first aspect of the present invention, a document management apparatus includes: a first requesting portion that requests a plurality of verification information issuing stations, which differ from one another in method of generating time-and-date verification information that gives proof of a time and date, to issue time-and-date verification information corresponding to a target document; a first receiving portion that receives the time-and-date verification information from each of the plurality of verification information issuing stations; a first storage that stores a plurality of pieces of the time-and-date verification information received by the first receiving portion, the time-and-date verification information linked to the target document; an acquiring portion that acquires information concerning whether certification information generated by each of the plurality of verification information issuing stations is valid or invalid; a second requesting portion that requests the verification information issuing station, which differs from each of the verification information issuing stations that generate invalid certification information, to issue new time-and-date verification information corresponding to the target document; a second receiving portion that receives the time-and-date verification information from the verification information issuing station requested by the second requesting portion; and a second storage that stores a plurality of pieces of the time-and-date verification information received by the second receiving portion, the time-and-date verification information linked to the target document.

### BRIEF DESCRIPTION OF THE DRAWINGS

Exemplary embodiment of the present invention will be described in detail based on the following figures, wherein:

FIG. 1 is a block view illustrating an example of the configuration of a document management apparatus according to an embodiment of the invention;

FIG. 2 is an explanatory view illustrating an example of a station database used by the document management apparatus according to the embodiment of the invention;

FIG. 3 is an explanatory view illustrating an example of long-term signature information generated by the document management apparatus according to the embodiment of the invention;

FIG. 4 is a functional block view illustrating an example of the document management apparatus according to the invention;

FIG. 5 is a flowchart illustrating a part of an operation of the document management apparatus according to the embodiment of the invention; and

FIG. 6 is a flowchart illustrating an example of an operation of the document management apparatus according to the embodiment of the invention.

### DETAILED DESCRIPTION

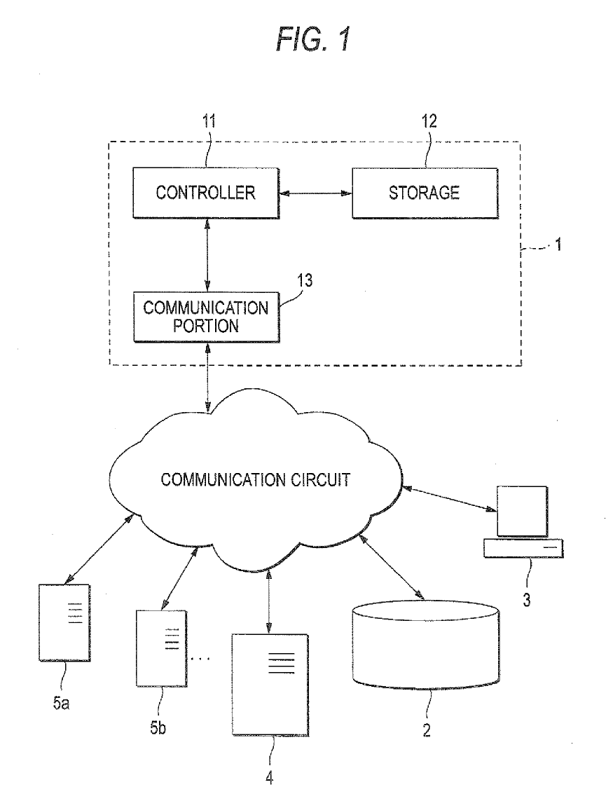

An embodiment of the invention is described below with reference to the accompanying drawings. A document management apparatus 1 according to the embodiment of the invention is implemented as an application server. As shown in FIG. 1, the document management apparatus 1 is configured to include a controller 11, a storate 12, and a communication portion 13. Also, the document management apparatus 1 is connected to a storage server (or repository server) 2, which stores documents, and to a user terminal 3. Moreover, the document management apparatus 1 is connected to a signature information issuing station 4 and to a plurality of verification information issuing stations 5a, 5b, through a communication circuit such as the Internet.

The controller 11 of the document management apparatus 1 is implemented by a program-controlled device such as a microprocessor. This controller 11 operates according to a program stored in the storate 12. According to the present embodiment, the controller 11 causes the signature information issuing station 4 and the verification information issuing station 5, such as a time-and-date information issuing station, to issue signature information and a timestamp to a target document that is one of the documents stored in the storage server 2. Then, the issued signature information and the issued timestamp are stored by being linked to the target document. Processing performed by the controller 11 will be described in detail later.

The storate 12 is configured to include a memory element, such as a RAM (Random Access Memory), and a recording medium, such as a hard disk. Programs to be executed by the controller 11 are held by the storate 12. The storate 12 operates as a work memory for the controller 11. Also, according to the present embodiment, a station database adapted to link selection criterion information, which includes information representing a generation method of generating time-and-date verification information, to information (representing a network address) specifying each of the verification information issuing stations 5 is held in the storate 12. Incidentally, the information representing the generation method of generating time-and-date verification information includes information specifying a hash function for generating an acceptable hash value, information specifying an encryption algorithm (such as information specifying a function used for encryption), information specifying the length of a private key used for encryption, information specifying a source of a certification, information specifying an operating entity, and information specifying a service protocol.

The communication portion 13 is connected to a communication circuit, such as the Internet. The communication portion 13 is, for example, a network interface (NIC), and sends out requested data to the storage server 2, the signature information issuing station 4, and the verification information issuing stations 5 according to instructions input from the controller 11.

The storage server 2 stores and holds documents uploaded from users. The storage server 2 receives input documents, which are to be registered, from, for example, the document management apparatus 1 serving as an application server, and causes a storage device to store the documents. The storage server 2 also causes the storage device according to instructions input from the document management apparatus 1 to store information, such as signature information and timestamps, by linking such information to each of the stored documents. Also, in response to an instruction input from the document management apparatus 1, the storage server 2 extracts the information, such as signature information and timestamps, linked to the stored document. Then, the storage server 2 sends the extracted information to the document management apparatus 1.

The user terminal 3 may be a personal computer capable of operating a web browser. The user terminal 3 selectively reads the document from, for example, the storage server 2, and performs processing, for instance, verifies whether any falsification is performed on the document.

The signature information issuing station 4 is, for example, a server operating as a certificate authority (CA) providing verification information. The signature information issuing station 4 provides certification information (including information needed for issuance of a timestamp and for verification) needed by the verification information issuing station 5 and also provides information relating to the revocation of the certification information (that is, provides information relating to CRL (Certificate Revocation List)).

Also, the signature information issuing station 4 causes a computer (for example, the user terminal 3), which can utilize a private key of a certification issued to the user, to generate information on a digital signature corresponding to a hash value of the target document. Additionally, the signature information issuing station 4 sends information on the digital signature to the storage server 2 in which the information sent thereto is stored by being linked to the document corresponding to the generated hash value.

The information (ES) on the digital signature additionally includes a signed attribute (Q), and signature information (R), as illustrated in FIG. 3.

The signature information is assumed to be stored in a format suitable for long-term storage. Hereinafter, a description will be made by assuming that a format, in which evidence data is stored, is a long-term signature format (ES-format) disclosed in Non-patent Document 1. However, as long as the validity of the signature can be assured by the combination of a technique of the digital signature and a technique of timestamping, the format, in which evidence data is stored, is not limited to the ES-format.

The verification information issuing stations 5 are servers acting as time-and-date verification issuing servers (TSA) that issue timestamps. The verification information issuing stations 5 are connected to a time information server (TA) that provides information representing a time and date. When receiving a request for issuing a timestamp, together with a hash value of a signed document to which the timestamp is applied, the verification information issuing station 5 acquires information, which represents a time and date at that time, from the time information server.

The verification information issuing station 5 encrypts the acquired information representing the time and date and the received hash value using a predetermined private key to thereby information called “a timestamp token”. Then, the verification information issuing station 5 sends the timestamp token to the apparatus having requested for issuance of the timestamp. The timestamp token is utilized as information giving proof of the time and date.

Incidentally, as illustrated in FIG. 3, information (ES-T) is obtained by adding a timestamp to the digital signature information ES. The information (ES-T) is stored in the storage server 2 by being linked to the target document, similarly to the information ES. The information (ES-T) includes the information ES. Thus the information ES and the information (ES-T) may be replaced with each other in the storage server 2.

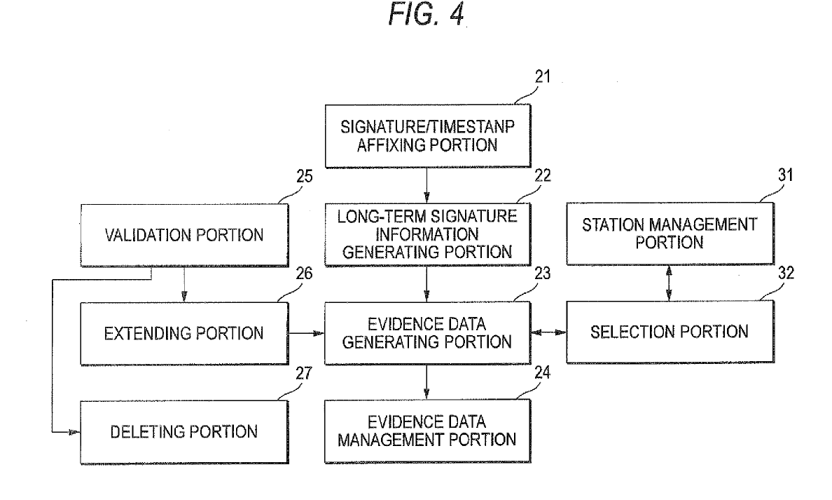

Next, an operation of the controller 11 of the document management apparatus 1 according to the present embodiment is described below. The program executed by the controller 11 is functionally constituted by inducing a signature/timestamp affixing portion 21, a long-term signature information generating portion 22, an evidence data generating portion 23, an evidence data management portion 24, a validation portion 25, an extending portion 26, a deleting portion 27, a station management portion 31, and a selection portion 32, as shown in FIG. 4.

The signature/timestamp affixing portion 21 generates digital signature information (ES) and requests a predetermined one (hereunder referred to as a first station) of the plurality of verification information issuing stations 5 to issue a timestamp.

In the case of a practical example, the signature/timestamp affixing portion 21 calculates a hash value, which can be accepted by the first station 5, according to the target document. This hash value is generated by a hash function specified by information linked to the first station 5 in the station database stored in the storate 12. Then, the signature/timestamp affixing portion 21 sends the calculated hash value to the first station 5.

The first station 5 encrypts the hash value of the target document, to which the time-and-date information, using the private key, thereby to generate a timestamp token. Subsequently, the time stamp token is sent to the document management apparatus 1 having requested the first station 5 to issue a timestamp. The document management apparatus 1 generates digital signature information (ES) corresponding to the hash value. Then, the document management apparatus 1 generates basic long-term signature information (ES-T) including the digital signature information (ES) and the timestamp token received from the station 5.

The signature/timestamp affixing portion 21 generates the basic long-term signature information (ES-T) and outputs the long-term signature information (ES-T) to the long-term signature information generating portion 22.

The long-term signature information generating portion 22 acquires all of certification information, which is needed for verification of the digital signature information (ES) included in the basic long-term signature information (ES-T), and also acquires reference information (for example, the information CRL) on information relating to the revocation of the certification information from the signature information issuing station 4.

The long-term signature information generating portion 22 generates long-term signature information (ES-C) obtained by adding validity information, which includes all of certification information needed for verification of the digital signature information (ES) and also includes reference information on information relating to the revocation of the certification information, to the basic long-term signature information (ES-T). The long-term signature information generating portion 22 also generates long-term signature information (ES-X) with verification information by adding all of certification information needed for verification of the digital signature information (ES) and information relating to the revocation of the certification information to the long-term signature information (ES-C). The long-term signature information (ES-X) with verification information is, for example, of the type generally called “ES-X long”. Although the information CRL is employed as the information relating to the revocation of the certification information, the information relating to the revocation of the certification information according to the invention is not limited thereto. What is called an OCSP response representing a result of an online inquiry about the validity may be employed as the information relating to the revocation of the certification information.

The long-term signature information generating portion 22 outputs the long-term signature information (ES-X) with verification information to the evidence data generating portion 23.

The evidence data generating portion 23 sends the target document and a hash value of long-term signature information to the verification information issuing station 5 selected by the selecting portion 32, which will be described later, and requests the selected verification information issuing station 5 to issue a timestamp. Then, the evidence data generating portion 23 receives a timestamp token from the selected verification information issuing station 5 and generates evidence data (ES-A) including the received timestamp token. The evidence data generating portion 23 outputs the generated evidence data (ES-A) to the evidence data management portion 24. Incidentally, the timestamp token issued by each of the verification information issuing stations 5a, 5b, . . . , is generally called “archive timestamp” and proves that a document, to which data for preventing the document from being tampered, is added, is present at the time and date represented by the timestamp token.

Processes performed by the evidence data generating portion 23 slightly vary with timing, that is, the process performed at the time of newly generating the evidence data, that performed at the time of extending the validity period of the evidence data, and that performed at the time of partly revoking the evidence data slightly differ from one another. Hereinafter, the process performed by the evidence data generating portion 23 in each of such cases is described.

Case of Newly Generating the Evidence Data

In this case, the evidence data generating portion 23 receives the long-term signature information (ES-X) with verification information from the long-term signature information generating portion 22. The evidence data generating portion 23 sends the target document and the hash value generated from the long-term signature information (ES-X) with verification information to the plurality of verification information issuing stations 5a, 5b, . . . , selected by the selecting portion 32, which will be described later, to request each of the selected verification information issuing stations 5a, 5b, . . . , to issue a timestamp. When receiving a timestamp token from each of the selected verification information issuing stations 5a, 5b, . . . , the evidence data generating portion 23 generates a plurality of evidence data (ES-Aa, ES-Ab, . . . ) obtained by adding the received timestamp tokens to the long-term signature information (ES-X) with verification information, respectively. Then, the evidence data generating portion 23 outputs the generated evidence data to the evidence data management portion 24.

Case of Extending the Validity Period of the Evidence Data

The evidence data generating portion 23 receives a validity period extending instruction and input evidence data from the extending portion 26, which will be described later. Then, the evidence data generating portion 23 extracts information specifying the verification information issuing station 5, which is a source of the archive timestamp added to the input evidence data at the last part thereof. Then, the evidence data generating portion 23 sends a document included in the evidence data and a hash value calculated from the input evidence data to the verification information issuing station 5 specified according to the extracted information. Then, the evidence data generating portion 23 newly generates evidence data by adding the timestamp token (or archive timestamp) issued corresponding to the sent hash value to the evidence data input from the extending portion 26. Subsequently, the evidence data generating portion 23 outputs the evidence data newly generated to the evidence data management portion 24.

Case of Revoking Part of the Evidence Data

The evidence data generating portion 23 receives a verification information issuing station changing instruction and a plurality of input evidence data corresponding to the target document, which include revoked evidence data and valid evidence data, from the extending portion 26, which will be described later. Then, the evidence data generating portion 23 extracts information (invalid-station information) specifying the verification information issuing station 5, which is a source of the archive timestamp added to the input revoked evidence data at the last part thereof. Also, the evidence data generating portion 23 extracts information (valid-station information) specifying the verification information issuing station 5, which is a source of the archive timestamp added to at least one of the input valid evidence data at the last part thereof. Subsequently, the evidence data generating portion 23 outputs the extracted invalid-station information and the extracted valid-station information to the selection portion 32, which will be described later. Then, the evidence data generating portion 23 causes the selection portion 32 to select another of the verification information issuing stations 5. At that time, the evidence data generating portion 23 controls the selection portion 32 not to select the verification information issuing station 5 represented by the extracted invalid-station information.

The evidence data generating portion 23 receives information specifying the another one of the verification information issuing station 5 selected by the selection portion 32. Then, the evidence data generating portion 23 sends a document included in the input evidence data and a hash value calculated from the evidence data to at least one of the verification information issuing station specified by the received information. Subsequently, the evidence data generating portion 23 generates new evidence data by adding a timestamp token (or archive timestamp) issued corresponding to the sent hash value to at least one of the valid evidence data among the evidence data input from the extending portion 26. Then, the evidence data generating portion 23 outputs the generated new evidence data to the evidence data management portion 24.

The evidence data management portion 24 links the evidence data output by the evidence data generating portion 23 to the target document and causes the storage server 2 to store the evidence data.

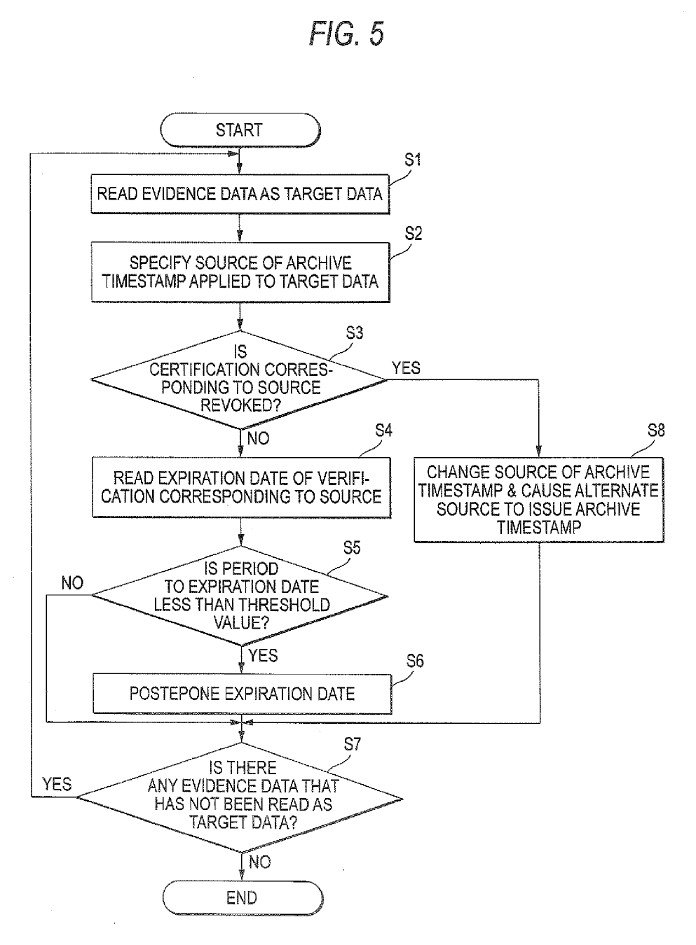

The validation portion 25 performs a process shown in FIG. 5. In step S1, the evidence data stored in the storage server 2 are serially read as target data. Then, the validation portion 25 verifies the validity of the target data. That is, the validation portion 25 specifies the source of an archive timestamp included at the last part (i.e., the latest archive timestamp) of the target data in step S2. Then, the validation portion 25 checks from the information CRL included in the evidence data in step S3 whether the certification information corresponding to the verification information issuing station 5, which is the specified source, is revoked. That is, in a case where the certification information is revoked, and where the archive timestamp generated by the verification information issuing station 5 corresponding to the certification information is applied after the revocation date of the certification information, the validation portion 25 determines that this evidence data is invalid.

If the certification information is not revoked (NO in step S3), the validation portion 25 acquires the certification information from the signature information issuing station 4 and reads the expiration date of the certification information in step S4. Then, the validation portion 25 further checks in step S5 whether the remaining term to the expiration date is less than a predetermined threshold value (it is advisable to subtract a current time and date acquired at the time of processing from a timer (not shown) from the expiration date). If so (YES in step S5), the validation portion 25 outputs the read evidence data to the extending portion 26, and instructs the extending portion 26 in step S6 to extend the expiration date. Furthermore, the validation portion 26 checks in step S7 whether there is any evidence data having been not read as target data. If so (YES in step S7), the process returns to step S1. Then, the apparatus continues to perform the process. Conversely, if there is no evidence data having been not read as target data in step S7, that is, if processing is completed on all the evidence data, the process is terminated.

If the remaining term to the read expiration date is not less than the predetermined threshold value in step S5 (NO in step S5), the process proceeds to step S7. Then, the validation portion 25 continues the process.

If the certification information is revoked in step S3 (YES in step S3), the validation portion 25 outputs the target data to the deleting portion 27. Also, in step S8, the validation portion 25 outputs to the extending portion 26 the target data and an instruction of changing the verification information issuing station 5. Then, the validation portion 25 proceeds to step S7 and continues the process.

When receiving from the validation portion 25 the evidence data and an instruction of postponing the expiration date, the extending portion 26 outputs to the evidence data generating portion 23 the evidence data together with the instruction of postponing the expiration date.

When receiving from the validation portion 25 the evidence data (determined to be invalid) and the instruction of changing the verification information issuing station 5, the extending portion 26 reads from the storage server 2 other valid evidence data corresponding to a target document that is the same as the invalid evidence data.

That is, because the present embodiment is configured so that a plurality of evidence data are linked to a single document, even when the plurality of evidence data are partly revoked, in a case where the rest of the evidence data includes valid evidence data, the valid evidence data can be read out.

The extending portion 26 outputs to the evidence data generating portion 23 the instruction of changing the verification information issuing station 5 together with the evidence data determined to be invalid, and with the valid evidence data.

When the evidence data determined to be invalid is input from the validation portion 25, the deleting portion 27 instructs the storage server 2 to delete this input evidence data.

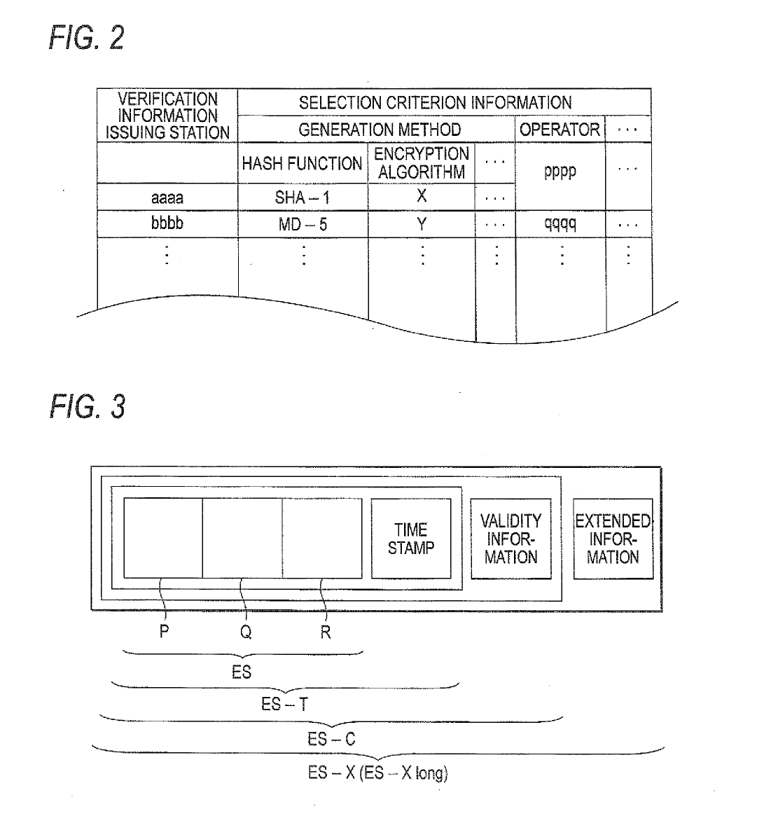

The station management portion 31 reads information representing the generation method of generating the time-and-date verification information from the station database shown in FIG. 2 in response to an instruction input from the selection portion 32. The station management portion 31 sets the verification information issuing stations 5, which are specified by the information stored in the station database as candidates, and selects the verification information issuing station 5, which meet specified conditions, from the candidates. Then, the station management portion 31 outputs information specifying the selected verification information issuing station 5.

According to a practical example, in a case where evidence data is newly generated, the selection portion 32 selects a plurality of verification information issuing stations 5, which differ from one another in method of generating time-and-date verification information (a timestamp) that gives proof of a time and date, from the candidates. For example, the selection portion 32 randomly selects one of the verification information issuing stations 5 from the candidates, and sets the selected verification information issuing station 5 as the first station. Next, the selection portion 32 reads data representing the generation method of generating the time-and-date verification information, which is employed by the first station, from the station database. Subsequently, the selection portion 32 searches the station database for the verification information issuing station 5, which differ from the first station in at least a part of the information representing the generation method. The selection portion 32 sets the verification information issuing station 5 found by the search as a second station. Then, the selection portion 32 outputs information representing (for example, the network addresses of) the first station and the second station.

Also, in a case where the certification information is revoked, where a part of the evidence data is thus revoked, and where it becomes necessary to change the verification information issuing station 5, the selection portion 32 generates from the candidates a set of selected candidates other than the verification information issuing stations 5 corresponding to the revoked certification information, which are specified by the invalid-station information input from the evidence data generating portion 23. The selection portion 32 selects from the set of selected candidates at least one of the verification information issuing stations 5, which differ in the method of generating the time-and-date information (or timestamp) from the verification information issuing station 5 (specified by the valid-station information input from the evidence data generating portion 23), which is used for generating the valid evidence data corresponding to the same document as that corresponding to the revoked evidence data.

For example, in a case where there are four candidates A, B, C, and D of the verification information issuing station 5, it is assumed that evidence data Xa including an archive timestamp issued by the verification information issuing station 5a corresponding to the candidate A and evidence data Xb including an archive timestamp issued by the verification information issuing station 5b corresponding to the candidate B are generated corresponding to a certain document, and that the certification information on the verification information issuing station 5a corresponding to the candidate A is revoked.

In this case, the candidate A specified by the invalid station information is excluded, so that the selection portion 32 selects the stations B, C, and D as the selected candidates. Then, the selection portion 32 reads data representing the generation method of generating the time-and-date station 5b corresponding to the candidate B from the station database. In this case, it is assumed that a hash function “SHA-1” is employed at each of the verification information issuing station 5b corresponding to the candidate B and the verification information issuing station 5d corresponding to the candidate D, and that a hash function “MD5” is employed at the verification information issuing station 5c corresponding to the candidate C. At that time, the selection portion 32 selects the verification information issuing station 5c corresponding to the candidate C, which differs in the hash function from the candidates B and D. The selection portion 32 outputs information specifying the verification information issuing station 5c corresponding to the candidate C.

The present embodiment has the above configuration and operates as follows. In the description of an example of an operation, it is assumed that there are four candidates A, B, C, and D of the verification information issuing station 5 specified by the information stored in the station database, that the hash function, the encryption algorithm, and the length of the private key, which are employed at the verification information issuing station 5a corresponding to the candidate A, are “SHA-1”, “X”, and L1 bits, that the hash function, the encryption algorithm, and the length of the private key, which are employed at the verification information issuing station 5b corresponding to the candidate B, are “SHA-1”, “Y”, and L2 bits, that the hash function, the encryption algorithm, and the length of the private key, which are employed at the verification information issuing station 5c corresponding to the candidate C, are “MD5”, “X”, and L3 bits, and that the hash function, the encryption algorithm, and the length of the private key, which are employed at the verification information issuing station 5d corresponding to the candidate D, are “SHA-1”, “X”, and L1 bits.

When a user specifies a document to the document management apparatus 1 as a target to be processed, and instructs the document management apparatus 1 to apply time-and-date verification information (or timestamp), the document management apparatus 1 reads the target document and generates long-term signature information (ES-X) with verification information. Then, the document management apparatus 1 selects a plurality of verification information issuing stations 5 that differ from one another in the generation method of generating the time-and-date verification information (or timestamp). In this case, it is assumed that the document management apparatus 1 selects the candidate A and the candidate B, which differs from the candidate A in both the encryption algorithm and the length of the private key, among the candidates stored in the station database.

The document management apparatus 1 generates a plurality of evidence data (hereunder respectively referred to as (ES-Aa) and (ES-Ab)) by adding archive timestamps respectively generated at the selected verification information issuing stations 5a and 5b to the generated long-term signature information (ES-X) with verification information.

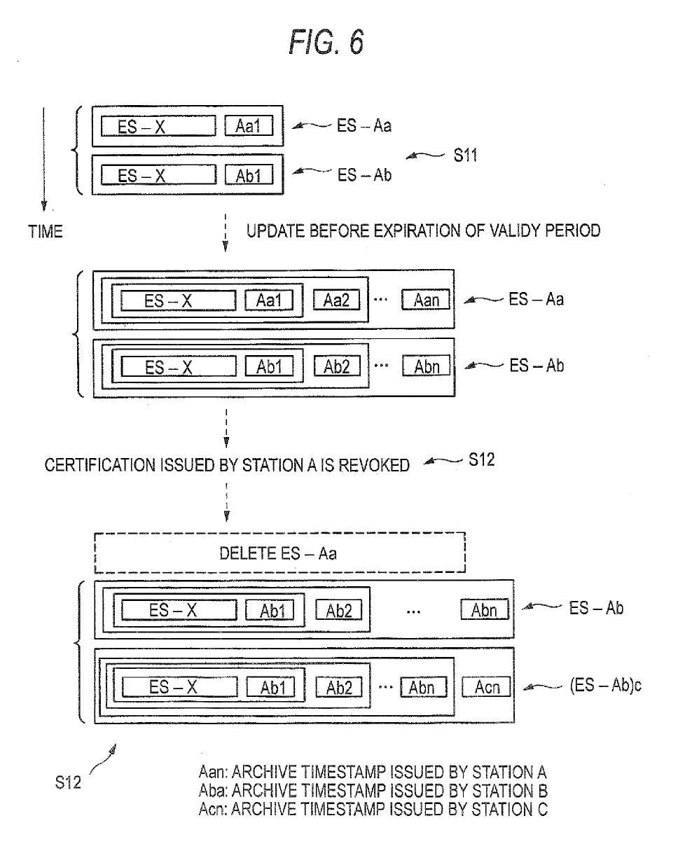

Then, a plurality of the generated evidence data (ES-Aa) and (ES-Ab) are stored in the storage server 2 by being linked to the target document (see S11 in FIG. 6). Thus, the document management apparatus 1 requests the plurality of verification information issuing stations, which differ from one another in the generation method of generating the time-and-date verification information that gives proof of a time and date, to issue time-and-date verification information according to the target document. Then, the document management apparatus 1 receives the time-and-date verification information from each of the plurality of verification information issuing stations. Subsequently, the document management apparatus 1 stores a plurality of pieces of the received time-and-date verification information by being linked to the target document. Thus, even when one of the pieces of the received time-and-date verification information is revoked for an unexpected reason, the document management apparatus 1 can reaffix a reliable timestamp to the document using another piece of the time-and-date verification information while the time-and-date verification is valid.

That is, when the certification information issued at the verification information issuing station 5a is revoked because, for example, an illegal operation by an operating entity is detected, the document management apparatus 1 determines that the evidence data (ES-Aa) including the archive timestamp issued at the verification information issuing station 5a is invalid (see S12 shown in FIG. 6).

Then, the invalid candidate A is excluded, so that the document management apparatus 1 selects the stations B, C, and D as the selected candidates. Also, the document management apparatus 1 reads data representing the generation method of generating the time-and-date station 5b corresponding to the candidate B, which corresponds to the evidence data having been in a valid state at that time, from the station database.

Then, the document management apparatus 1 selects one of the verification information issuing stations 5, which differ from the issuing station corresponding to the candidate B in the generation method of generating the time-and-date verification information (or timestamp). In this case, the verification information issuing station 5c corresponding to the candidate C is selected, because of the facts that the verification information issuing station 5c corresponding to the candidate C differs from the issuing station corresponding to the candidate B in the hash function, the encryption algorithm, and the length of the private key and that the difference in such a respect between the verification information issuing stations respectively corresponding to the candidates B and C is larger than the difference in such a respect between the verification information issuing stations respectively corresponding to the candidates B and D.

The document management apparatus 1 causes the storage server 2 to delete the evidence data (ES-Aa). Also, the document management apparatus 1 extends the validity period of the evidence data (ES-Ab) by adding an archive timestamp issued at the verification information issuing station 5c to the evidence data (ES-Ab), which is valid at that time, to thereby generate new evidence data (ES-Ab)c.

Then, the document management apparatus 1 links each of the generated new evidence data (ES-Ab)c and another valid evidence data (Es-Ab) to the target document and causes the storage server 2 to store the evidence data (ES-Ab)c and (Es-Ab) (see S13 shown in FIG. 6).

Thus, the present embodiment is adapted so that there are a plurality of verification information issuing stations 5 serving as the source of the last applied archive timestamp (that is, the “outermost” archive timestamp).

In the case of the example shown in FIG. 6, the plurality of verification information issuing stations 5 are provided by generating the evidence information (ES-Ab)c, to the last part of which the archive timestamp issued at the verification information issuing station 5c is applied, together with the evidence information (ES-Ab), to the last part of which the archive timestamp issued at the verification information issuing station 5b is applied. The example illustrated in FIG. 6 corresponds to the fact that when an initial state (corresponding to an nth generation) of the evidence information is changed to the next state (corresponding to an (n+1)-th generation) thereof by applying an archive timestamp to the evidence information of the nth generation to thereby extend the validity period thereof, only one piece of evidence information of the (n+1)-th generation differing from the evidence data of the nth generation is generated. This is a relatively simple method of extending the validity period of the evidence information of the nth generation when it becomes close to the expiration date of the validity of the evidence information. Safety against the invalidation of the evidence information can be assured.

Also, it is advisable to employ a method of updating a plurality of pieces of evidence information as a safer method. Thus, at that time, the latest safer technique can be utilized. Additionally, the expiration date of the validity of the timestamp can be extended.

That is, new pieces of evidence information (ES-Ab)d and (ES-Ab)e may be generated by adding archive timestamps issued at the verification information issuing stations 5d and 5e to the evidence information (ES-Ab).

This method is to generate a plurality of (for example, 2 of) pieces of the evidence information of the (n+1)-th generation, which differs from the evidence information of the nth generation. Safety is enhanced by newly applying the latest algorithm to a plurality of pieces of evidence information.

A still another method is to extend the validity period of a part of pieces of the evidence information, using the same verification information issuing station 5 as used the last time for issuing an archive stamp. For example, evidence information (ES-Ab)b is generated by causing the verification information issuing station 5b, which is the source of the archive timestamp added to the last part of the evidence information (ES-Ab) to newly issue an archive timestamp. On the other hand, evidence information (ES-Ab)e is generated by adding an archive timestamp issued by, for example, the verification information issuing station 5 (for example, the verification information issuing station 5e) that differs from the verification information issuing station 5b. This is a method of replacing a part of the evidence information of the nth generation with different evidence information thereof and also generating one piece of evidence information of the (n+1)-th generation using the same station as that used for issuing an archive timestamp to be added to the evidence information of the nth generation. In the case of extending the validity period of the evidence information using the same station to issue an archive timestamp, there is still a risk of invalidation of the evidence information. However, the validity period of the evidence information can be extended. Thus, a risk of failing to extend the validity period can be reduced.

In addition to the above methods, a method of newly generating evidence data in a system is to use evidence data (ES-Ax) preliminarily generated in another system utilizing, for example, an archive timestamp. In this case, the following method may be employed. In a case where digital signature information (ES) included in the preliminarily generated evidence data (ES-Ax) is valid at the time of verification, the verification information issuing station 5x, which is the source of the archive timestamp added to the evidence data (ES-Ax), is specified. Then, another verification information issuing station 5y, which differs from the verification information issuing station 5x in the generation method of generating the time-and-date verification information (or timestamp), is selected. Subsequently, the verification information issuing station 5y is caused to issue an archive timestamp. Then, evidence data (ES-Ay) is generated by adding the archive timestamp issued at the verification information issuing station 5y to the long-term signature information (ES-X) with verification information, which is included by the evidence data (ES-Ax). Thus, the original evidence data (ES-Ax) and the newly generated evidence data (ES-Ay) are held by being linked to the corresponding document.

In a case where the digital signature information (ES) included in the preliminarily generated evidence data (ES-Ax) is invalid at verification performed when receiving the data, and where the validity of the information (ES) can be assured by the data (ES-Ax), evidence data can be generated by using a plurality of verification information issuing stations and by repeatedly affixing an archive timestamp. Additionally, the generated evidence data can be stored in the storage server.

Although an archive timestamp is affixed to the last part of evidence data and the evidence data of the number of the verification information issuing stations are managed by being linked to a target document in the practical examples described hereinabove, the evidence data and the target document may be managed in a one-to-one relationship by applying archive timestamps of the number of the verification information issuing stations, which are the same as an archive timestamp affixed to the last part of one piece of evidence information, to a plurality of pieces of evidence information in parallel.

What is claimed is:

1. A document management apparatus comprising:
a first requesting portion that requests a plurality of verification information issuing stations, which differ from one another in method of generating time-and-date verification information that gives proof of a time and date, to issue time-and-date verification information corresponding to a target document;
a first receiving portion that receives the time-and-date verification information from each of the plurality of verification information issuing stations;
a first storage that stores a plurality of pieces of the time-and-date verification information received by the first receiving portion, the time-and-date verification information linked to the target document;
an acquiring portion that acquires information concerning whether certification information generated for each of the plurality of verification information issuing stations is valid or invalid;
a second requesting portion that requests a verification information issuing station, which differs from a verification information issuing station of which the certification information is invalid, to issue time-and-date verification information corresponding to the target document;
a second receiving portion that receives the time-and-date verification information from the verification information issuing station requested by the second requesting portion; and
a second storage that stores the time-and-date verification information received by the second receiving portion, the time-and-date verification information linked to the target document.

2. The document management apparatus as claimed in claim 1, further comprising:
a first selecting portion that refers to a station database holding information about the plurality of verification information issuing station, the information includes a method of generating the time-and-date verification information, and that selects the plurality of verification information issuing stations to be requested to issue time-and-date verification information.

3. The document management apparatus as claimed in claim 1, further comprising:
a second selecting portion that receives source information specifying the verification information issuing station that issues the time-and-date information linked to the target document, that refers to a station database holding information about the plurality of verification information issuing stations, the information includes a method of generating the time-and-date verification information, and that selects at least one of the plurality of verification information issuing stations of which the method of generating the time-and-date verification information is different from the method of a verification information issuing station which is specified by the source information.

4. A computer readable medium storing a program causing a computer to execute a process for managing a document, the process comprising:
first requesting a plurality of verification information issuing stations, which differ from one another in method of generating time-and-date verification information that gives proof of a time and date, to issue time-and-date verification information corresponding to a target document;
first receiving the time-and-date verification information from each of the plurality of verification information issuing stations;
first storing a plurality of pieces of the received time-and-date verification information, which are linked to the target document;
acquiring information concerning whether certification information generated for each of the plurality of verification information issuing stations is valid or invalid;
second requesting a verification information issuing station, which differs from a verification information issuing station of which the certification information is invalid, to issue time-and-date verification information corresponding to the target document;
second receiving the time-and-date verification information from the verification information issuing station requested in the second requesting; and
second storing the time-and-date verification information received in the second receiving, the time-and-date verification information linked to the target document.

5. The computer readable medium according to claim 4, the process further comprising:
referring to a station database holding information about the plurality of verification information issuing stations, the information includes a method of generating the time-and-date verification information; and
selecting the plurality of verification information issuing stations to be requested to issue the time-and-date verification information.

6. The computer readable medium according to claim 4, the process further comprising:
receiving source information which specifies the verification information issuing station that issues the time-and-date information linked to the target document;
referring to a station database holding information about the plurality of verification information issuing stations, the information includes a method of generating the time-and-date verification information; and
selecting at least one of the plurality of verification information issuing stations of which the method of generating the time-and-date verification information is different from the method of a verification information issuing station which is specified by the source information.

7. A method for managing a document comprising:
first requesting a plurality of verification information issuing stations, which differ from one another in method of generating time-and-date verification information that gives proof of a time and date, to issue time-and-date verification information corresponding to a target document;
first receiving the time-and-date verification information from each of the plurality of verification information issuing stations;
first storing a plurality of pieces of the received time-and-date verification information, which are linked to the target document;
acquiring information concerning whether certification information generated for each of the plurality of verification information issuing stations is valid or invalid;
second requesting a verification information issuing station, which differs from a verification information issuing station of which the certification information is invalid, to issue time-and-date verification information corresponding to the target document;
second receiving the time-and-date verification information from the verification information issuing station requested in the second requesting; and
second storing the time-and-date verification information received in the second receiving, the time-and-date verification information linked to the target document.

8. The method according to claim 7, further comprising:
referring to a station database holding information about the plurality of verification information issuing stations, the information includes a method of generating the time-and-date verification information; and
selecting the plurality of verification information issuing stations to be requested to issue the time-and-date verification information.

9. The method according to claim 7, further comprising:
receiving source information which specifies the verification information issuing station that issues the time-and-date information linked to the target document;
referring to a station database holding information about the plurality of verification information issuing stations, the information includes a method of generating the time-and-date verification information; and
selecting at least one of the plurality of verification information issuing stations of which the method of generating the time-and-date verification information is different from the method of a verification information issuing station which is specified by the source information.

10. A computer data signal embodied in a carrier wave for enabling a computer to perform a process for managing a document, the process comprising:
first requesting a plurality of verification information issuing stations, which differ from one another in method of generating time-and-date verification information that gives proof of a time and date, to issue time-and-date verification information corresponding to a target document;
first receiving the time-and-date verification information from each of the plurality of verification information issuing stations;
first storing a plurality of pieces of the received time-and-date verification information, which are linked to the target document;
acquiring information concerning whether certification information generated for each of the plurality of verification information issuing stations is valid or invalid;
second requesting a verification information issuing station, which differs from a verification information issuing station of which the certification information is invalid, to issue time-and-date verification information corresponding to the target document;
second receiving the time-and-date verification information from the verification information issuing station requested in the second requesting; and
second storing the time-and-date verification information received in the second receiving, the time-and-date verification information linked to the target document.

11. The computer data signal according to claim 10, the process further comprising:
referring to a station database holding information about the plurality of verification information issuing stations, the information includes a method of generating the time-and-date verification information; and
selecting the plurality of verification information issuing stations to be requested to issue the time-and-date verification information.

12. The computer readable medium according to claim 10, the process further comprising:
receiving source information which specifies the verification information issuing station that issues the time-and-date information linked to the target document;
referring to a station database holding information about the plurality of verification information issuing stations, the information includes a method of generating the time-and-date verification information; and
selecting at least one of the plurality of verification information issuing stations of which the method of generating the time-and-date verification information is different from the method of a verification information issuing station which is specified by the source information.
